(19) United States
(12) Patent Application Publication
(10) Pub. No.: US 2026/0235821 A1
(43) Pub. Date: Aug. 13, 2026

(54) OPTICAL CONNECTOR AND METHOD FOR PRODUCING OPTICAL CONNECTOR

(71) Applicant: Fujikura Ltd., Tokyo (JP)

(72) Inventor: Hiroki Nakane, Sakura-shi (JP)

(73) Assignee: Fujikura Ltd., Tokyo (JP)

(21) Appl. No.: 19/155,360

(22) PCT Filed: Feb. 9, 2024
(86) PCT No.: PCT/JP2024/004672

§ 371 Date: Aug. 11, 2025

(30) Foreign Application Priority Data
Feb. 13, 2023 (JP) 2023-019753

(51) Int. Cl. G02B 6/40; G02B 6/38

(52) U.S. Cl. CPC G02B 6/403; G02B 6/3861

(57) ABSTRACT

An optical connector includes three or more optical fibers, a holding agent holding a relative positioning of the three or more optical fibers, and a ferrule having a fiber hole into which the three or more optical fibers are inserted together with the holding agent. In a cross section perpendicular to a longitudinal direction of the fiber hole, a core of each of the three or more optical fibers is disposed on an imaginary circumference, adjacent optical fibers of the three or more optical fibers contact each other in a circumferential direction, and the holding agent is disposed, in a radial direction of the imaginary circumference, inward of a point where the adjacent optical fibers contact each other.

### CROSS-REFERENCE TO RELATED APPLICATIONS

The present application is a national phase application of International Application No. PCT/JP2024/004672, filed Feb. 9, 2024, which claims priority to Japanese Patent Application No. 2023-019753, filed Feb. 13, 2023. The contents of these applications are incorporated herein by reference in their entirety.

### BACKGROUND

### Technical Field

The present invention relates to an optical connector and a method for producing an optical connector.

### Discussion of the Background

Patent Document 1 discloses a fiber bundle including a plurality of optical fibers. Such a fiber bundle is used as, for example, a part of an optical connector.

### Patent Document

Patent Document 1: Japanese Patent Publication No. 2008-511871

In the optical connector including the plurality of optical fibers, the plurality of optical fibers may be inserted into one fiber hole of a ferrule. Here, in a case where the diameter of the optical fiber is reduced in order to dispose the optical fibers at a high density, the rigidity of the optical fiber is reduced. As a result, the optical fiber may be disposed inside the fiber hole in a locally bent state, and the transmission loss of light may increase.

### SUMMARY

One or more embodiments provide an optical connector and a method for producing the optical connector, which can suppress an increase in transmission loss of light.

An optical connector according to a first aspect of one or more embodiments includes three or more optical fibers; a holding agent configured to hold disposition of the optical fibers relative to each other; and a ferrule configured to have a fiber hole into which the three or more optical fibers are inserted together with the holding agent, in a cross section perpendicular to a longitudinal direction of the fiber hole, a core of each of the three or more optical fibers is disposed on an imaginary circumference, optical fibers among the three or more optical fibers, which are adjacent to each other in a circumferential direction, are in contact with each other, and the holding agent is disposed further inside the imaginary circumference in a radial direction than at points where the optical fibers are in contact with each other.

A second aspect of one or more embodiments is the optical connector according to the first aspect, in which each of the three or more optical fibers may have a smaller-diameter portion that is positioned inside the fiber hole and a larger-diameter portion that is positioned outside the fiber hole and has a diameter larger than a diameter of the smaller-diameter portion.

A third aspect of one or more embodiments is the optical connector according to the first or second aspect, further including a fixing agent configured to fix the three or more optical fibers in the fiber hole, in which a material of the holding agent may be different from a material of the fixing agent.

A fourth aspect of one or more embodiments is the optical connector according to the third aspect, in which a Young's modulus of the holding agent may be smaller than a Young's modulus of the fixing agent.

A fifth aspect of one or more embodiments is the optical connector according to any one of the first to fourth aspects, in which the fiber hole may have a linear portion and a curved portion in the cross section.

A method for producing an optical connector according to a sixth aspect of one or more embodiments includes aligning three or more optical fibers in a first direction perpendicular to a longitudinal direction of the optical fibers; making a holding agent adhere to the optical fibers from one side in a second direction perpendicular to both the longitudinal direction and the first direction; rolling a strip-shaped unit including the three or more optical fibers such that the optical fibers surround the holding agent; inserting the rolled strip-shaped unit into a fiber hole of a ferrule; and injecting a fixing agent into the fiber hole to fix the strip-shaped unit in the fiber hole by the fixing agent.

A seventh aspect of one or more embodiments is the method for producing an optical connector according to the sixth aspect, further including: rolling the strip-shaped unit inside an insertion tool and extending the rolled strip-shaped unit from a distal end of the insertion tool; and inserting the strip-shaped unit extended from the distal end of the insertion tool into the fiber hole.

According to one or more embodiments, it is possible to provide an optical connector and a method for producing the optical connector, which can suppress an increase in transmission loss of light.

### BRIEF DESCRIPTION OF THE DRAWINGS

FIG. 1 is a perspective view of an optical connector according to one or more embodiments.

FIG. 2 is a perspective view of the optical connector shown in FIG. 1 from which a plurality of optical fibers are extracted.

FIG. 3 is a cross-sectional view taken along line III-III of FIG. 1.

FIG. 4 is a diagram showing a method for producing the optical connector according to one or more embodiments.

FIG. 5 is an example of an insertion tool used when producing the optical connector according to one or more embodiments.

### DESCRIPTION OF THE EMBODIMENTS

Hereinafter, an optical connector and a method for producing the optical connector according to one or more embodiments will be described with reference to the drawings.

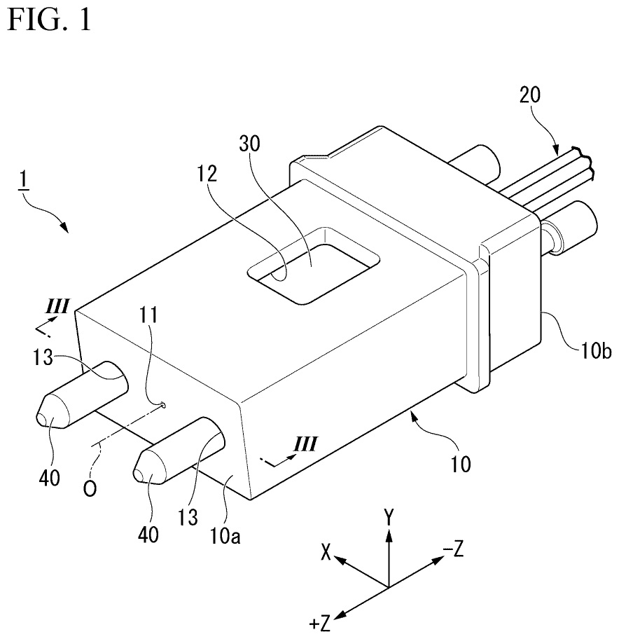

As shown in FIG. 1, an optical connector 1 includes a ferrule 10, a plurality of optical fibers 20, a fixing agent 30, and two positioning pins 40. The optical connector 1 may not include the positioning pins 40. In one or more embodiments, the number of optical fibers 20 is four. However, the number of optical fibers 20 included in the optical connector 1 can be appropriately changed as long as the number is three or more.

The ferrule 10 has a connection end face 10a, a rear end face 10b, a fiber hole 11, an injection hole 12, and two positioning holes 13. The connection end face 10a is a face that is butted against another connector or the like in a case where the optical connector 1 is connected to the other connector or the like. The fiber hole 11 and the two positioning holes 13 are open to the connection end face 10a. An introduction hole (not shown) communicating with the fiber hole 11 is open to the rear end face 10b, and a plurality of optical fibers 20 are introduced into the ferrule 10 through the introduction hole. The positioning pin 40 is inserted into each of the two positioning holes 13.

Here, in recent years, in the field of optical networks, the adoption of a so-called fan-in, fan-out structure using a multi-core fiber (hereinafter, referred to as MCF) has been promoted. The MCF has a plurality of cores in one cladding. In the fan-in, fan-out structure, a plurality of single core fibers (hereinafter, referred to as SCFs) are connected to one MCF to branch optical wiring. In order to connect the plurality of SCFs to a plurality of cores of the MCF, it is necessary to fix the plurality of SCFs to correspond to the disposition of the cores of the MCF.

The optical connector 1 according to one or more embodiments is suitable for realizing the fan-in, fan-out structure. That is, the plurality of optical fibers 20 included in the optical connector 1 can be used as the plurality of SCFs included in the fan-in, fan-out structure. In addition, another optical connector that is a connection partner of the optical connector 1 may have the MCF. However, the optical connector 1 may be used for purposes other than the fan-in, fan-out structure. In addition, the optical fibers 20 included in the optical connector 1 may not be the SCFs.

### Definition of Direction

In the present specification, a direction parallel to a central axis O of the fiber hole 11 is referred to as a Z direction, an axial direction, or a longitudinal direction Z. The longitudinal direction Z matches a longitudinal direction of the optical fiber 20 inserted into the fiber hole 11. One direction perpendicular to the longitudinal direction Z is referred to as a first direction X. The first direction X is also a direction in which the two positioning holes 13 are aligned. A direction perpendicular to both the longitudinal direction Z and the first direction X is referred to as a second direction Y. A direction from the rear end face 10b toward the connection end face 10a of the ferrule 10 along the longitudinal direction Z is referred to as a +Z direction, a forward direction, or a distal end side. A direction opposite to the +Z direction is referred to as a −Z direction, a rearward direction, or a proximal end side.

A direction intersecting the central axis O as viewed from the longitudinal direction Z is referred to as a radial direction. An orientation toward the central axis O along the radial direction is referred to as a radially inner side, and an orientation away from the central axis O along the radial direction is referred to as a radially outer side. A direction that rotates around the central axis O as viewed from the longitudinal direction Z is referred to as a circumferential direction. A section perpendicular to the longitudinal direction Z is referred to as a cross section. That is, the cross section is a section extending along the first direction X and the second direction Y. The circumferential direction and the radial direction defined as described above match a circumferential direction and a radial direction on an imaginary circumference C described below.

In the connection end face 10a, the fiber hole 11 is disposed to be interposed between the two positioning holes 13. The injection hole 12 is open to one end face of the ferrule 10 facing the second direction Y. The injection hole 12 communicates with an inner space of the ferrule 10 and the fiber hole 11. In a case where the optical connector 1 is assembled, the fixing agent 30 is injected into the ferrule 10 through the injection hole 12. The injected fixing agent 30 also enters the inside of the fiber hole 11.

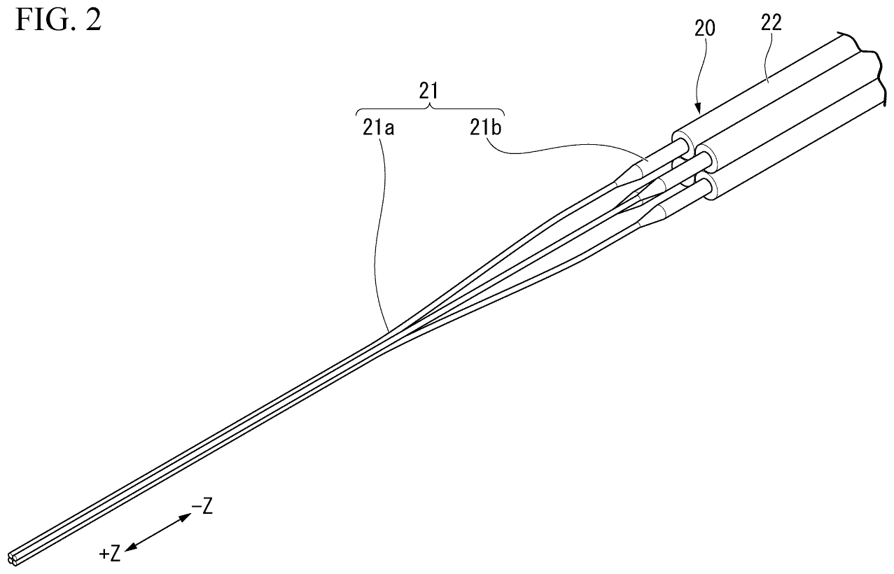

FIG. 2 is a view showing the plurality of optical fibers 20 shown in FIG. 1 extracted. Each optical fiber 20 has a bare fiber 21 and a coating 22. The bare fiber 21 is formed of, for example, silica glass. The coating 22 partially covers the bare fiber 21 and has a function of protecting the bare fiber 21. The coating 22 is formed of a resin or the like. For example, the material of the coating 22 may be a UV curable resin. At a front end portion of the optical fiber 20, no coating 22 is provided, and the bare fiber 21 is exposed. The exposed bare fiber 21 is inserted into the fiber hole 11 of the ferrule 10.

The bare fiber 21 has a smaller-diameter portion 21a and a larger-diameter portion 21b. The outer diameter of the smaller-diameter portion 21a is smaller than the outer diameter of the larger-diameter portion 21b. The smaller-diameter portion 21a can be formed by, for example, thinning an end portion of the bare fiber 21 having a constant outer diameter (the same outer diameter as the larger-diameter portion 21b) in the longitudinal direction Z by etching. In one or more embodiments, the smaller-diameter portion 21a is inserted into the fiber hole 11 of the ferrule 10. That is, the smaller-diameter portion 21a is positioned inside the fiber hole 11, and the larger-diameter portion 21b is positioned outside the fiber hole 11.

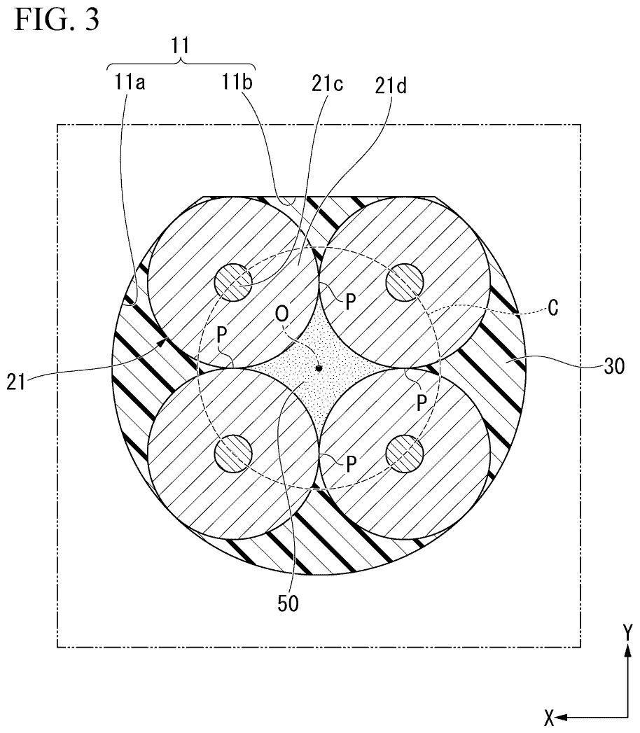

FIG. 3 is a cross-sectional view of the vicinity of the fiber hole 11. As shown in FIG. 3, the bare fiber 21 has a core 21c and a cladding 21d. The cladding 21d is disposed to surround the core 21c. The refractive index of the cladding 21d is lower than the refractive index of the core 21c. Therefore, the optical fiber 20 can confine light inside the core 21c.

As shown in FIG. 3, the fiber hole 11 of one or more embodiments has a curved portion 11a and a linear portion 11b as viewed in the longitudinal direction Z. The curved portion 11a has an arc shape. That is, the fiber hole 11 has a D-shape. Two bare fibers 21 among the four bare fibers 21 abut against both the curved portion 11a and the linear portion 11b. The remaining two bare fibers 21 abut against the curved portion 11a but do not abut against the linear portion 11b. The four bare fibers 21 are positioned by being pressed against the inner surface of the fiber hole 11.

As shown in FIG. 3, the optical connector 1 includes a holding agent 50 in addition to the fixing agent 30. The fixing agent 30 has a function of fixing the plurality of optical fibers 20 to the ferrule 10. The fixing agent 30 fills a gap between the inner surface of the fiber hole 11 and the outer peripheral surface of the optical fiber 20 (the bare fiber 21). The holding agent 50 has a function of holding relative positions of the plurality of optical fibers 20 before the optical fibers 20 are fixed by the fixing agent 30.

Here, a dashed line C shown in FIG. 3 is an imaginary circumference centered on the central axis O. In addition, a point where the claddings 21d of the optical fibers 20 adjacent to each other in the circumferential direction are in contact with each other is represented by a reference numeral P. In one or more embodiments, since there are four optical fibers 20, there are also four points P. The core 21c of each optical fiber 20 is disposed on the imaginary circumference C. In addition, the holding agent 50 is disposed only inside the point P in the radial direction.

Next, an example of a method for producing the optical connector 1 will be described.

First, a preparation step is performed. In the preparation step, the ferrule 10, the plurality of optical fibers 20, the fixing agent 30, the insertion tool 60, and the like are prepared. The insertion tool 60 will be described below. In the preparation step, the coating 22 at a distal end portion of the optical fiber 20 is removed, and the bare fiber 21 is exposed. As necessary, the exposed bare fiber 21 is subjected to an etching treatment or the like to form the smaller-diameter portion 21a.

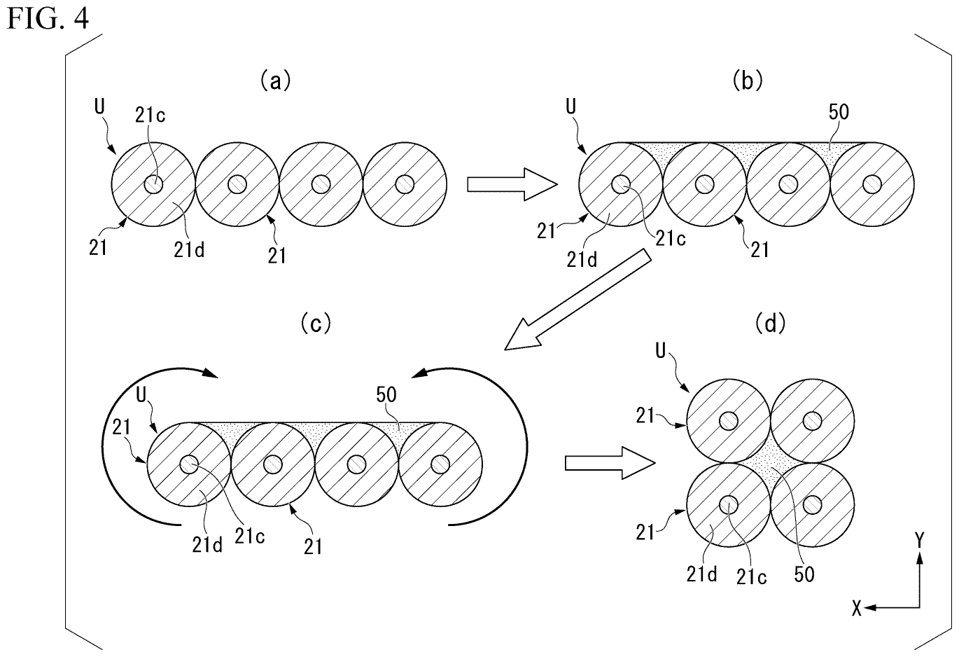

Next, a parallel step is performed. In the parallel step, as shown in (a) of FIG. 4, the plurality of optical fibers 20 (bare fibers 21) are aligned in the first direction X. The plurality of optical fibers 20 aligned in this way are referred to as a “strip-shaped unit U” in the present specification. The strip-shaped unit U has a flat shape in which a width (dimension in the first direction X) is larger than a thickness (dimension in the second direction Y).

Next, an adhesion step is performed. In the adhesion step, as shown in (b) of FIG. 4, the holding agent 50 is made to adhere to the plurality of optical fibers 20 from one side in the second direction Y. In this case, the holding agent 50 may be in a liquid state. After the adhesion step, the holding agent 50 may be cured as necessary.

Next, a rolling step is performed. In the rolling step, the strip-shaped unit U is rolled with the holding agent 50 inside as shown in (c) and (d) of FIG. 4.

Next, an insertion step is performed. In the insertion step, the bare fibers 21 of the rolled strip-shaped unit U are inserted into the fiber hole 11 of the ferrule 10.

Next, an injection step is performed. In the injection step, the fixing agent 30 having fluidity is injected into the ferrule 10 through the injection hole 12. The fixing agent 30 may be actively allowed to enter the fiber hole 11 by suctioning the fiber hole 11 that is open on the connection end face 10a by vacuum or the like. Alternatively, the fixing agent 30 may be allowed to enter the fiber hole 11 due to the capillary force or the like generated in the fiber hole 11.

Next, a fixing step is performed. In the fixing step, the fixing agent 30 is cured to fix the bare fibers 21 to the ferrule 10. For example, in a case where the fixing agent 30 is a thermosetting resin such as an epoxy resin, the fixing agent 30 is heated to a temperature equal to or higher than a curing temperature. In a case where the fixing agent 30 is not the thermosetting resin, the fixing agent 30 may be cured by a method other than the heating. For example, in a case where the fixing agent 30 is a UV curable resin, the fixing step may be performed by irradiating the fixing agent 30 with UV light.

As described above, the plurality of optical fibers 20 can be fixed to the ferrule 10. The optical connector 1 is obtained by attaching another member (the positioning pins 40 or the like) to the ferrule 10 as necessary.

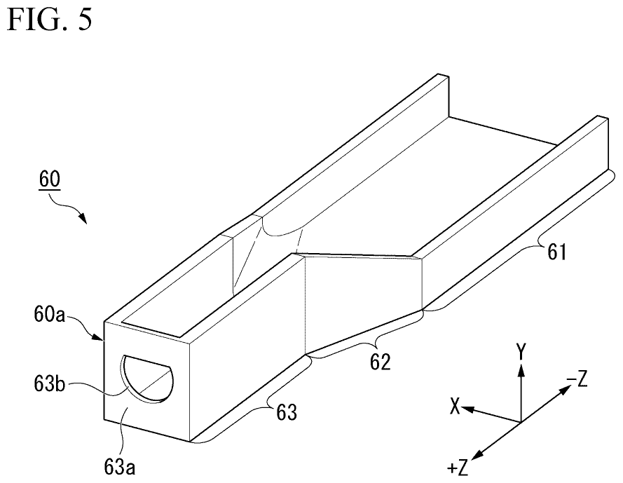

Next, the insertion tool 60 that can be used when producing the optical connector 1 will be described with reference to FIG. 5. The coordinate axes shown in FIG. 5 are examples for description. In a case where the optical fiber 20 is inserted into the fiber hole 11 using the insertion tool 60, the orientations of the Z axes in the ferrule 10 and the insertion tool 60 may substantially match each other.

As shown in FIG. 5, the insertion tool 60 includes a wide portion 61, a tapered portion 62, and a rolling maintaining portion 63. The rolling maintaining portion 63 is positioned on the distal end side with respect to the tapered portion 62, and the tapered portion 62 is positioned on the distal end side with respect to the wide portion 61. A plurality of optical fibers 20 can be disposed in parallel in the wide portion 61. The width of the tapered portion 62 in the first direction X decreases toward the distal end side. In the first direction X, the width of the rolling maintaining portion 63 is smaller than the width of the wide portion 61. The rolling maintaining portion 63 has a function of maintaining a state in which the strip-shaped unit U is rolled.

The wide portion 61, the tapered portion 62, and the rolling maintaining portion 63 have a shape that is open toward one side in the second direction Y. A wall portion 63a is provided at a distal end 60a of the insertion tool 60. The wall portion 63a is disposed to close a front end portion of the rolling maintaining portion 63. An insertion hole 63b is formed in the wall portion 63a. The insertion hole 63b penetrates the wall portion 63a in the longitudinal direction Z.

The shape of the insertion hole 63b corresponds to the shape of the fiber hole 11. For example, the insertion hole 63b has the same D shape (see FIG. 3) as the fiber hole 11 as viewed from the longitudinal direction Z. In addition, the size of the insertion hole 63b is substantially the same as the size of the fiber hole 11. Therefore, in a case where the plurality of optical fibers 20 is extended from the insertion hole 63b, the extended optical fibers 20 can be smoothly inserted into the fiber hole 11.

The insertion tool 60 can be used in the rolling step and the insertion step in the above-described method for producing the optical connector 1. Specifically, the strip-shaped unit U is disposed in the wide portion 61 in an expanded state (see (b) of FIG. 4). Next, the strip-shaped unit U is moved to the distal end side inside the insertion tool 60. Then, the strip-shaped unit U abuts against the inner surface of the tapered portion 62, and the strip-shaped unit U is rolled. In this manner, the rolling step can be performed.

The rolled strip-shaped unit U is further moved to the distal end side inside the insertion tool 60. Then, the rolled strip-shaped unit U passes through the rolling maintaining portion 63 and the insertion hole 63b, and extends from the insertion hole 63b. In this way, the strip-shaped unit U extended from the insertion tool 60 is inserted into the fiber hole 11. The insertion step can be performed in this manner.

Next, the materials of the holding agent 50 and the fixing agent 30 will be described. It is preferable that the holding agent 50 has a material different from that of the fixing agent 30. More specifically, it is preferable that the Young's modulus of the holding agent 50 is smaller than the Young's modulus of the fixing agent 30. The Young's modulus of the holding agent 50 is, for example, preferably 500 MPa or less. The Young's modulus of the fixing agent 30 is, for example, preferably 1000 MPa or more.

A small Young's modulus of the holding agent 50 means that the holding agent 50 is soft and easily deformed. Since the holding agent 50 is soft, the plurality of optical fibers 20 of which the relative positions are held by the holding agent 50 can be deformed to some extent. Therefore, the workability in a case where the plurality of optical fibers 20 are inserted into the fiber hole 11 is improved. Since the Young's modulus of the fixing agent 30 is large, the movement of the optical fiber 20 inside the fiber hole 11 can be suppressed. Accordingly, since the position of each core 21c is stabilized, the optical connection between the optical connector 1 and the other optical connector is stabilized.

The Poisson's ratio of the holding agent 50 is, for example, preferably 0.2 or less. In a case where the Poisson's ratio of the holding agent 50 is 0.2 or less, a volume change is likely to occur in the holding agent 50. In addition, the holding agent 50 is less likely to be distorted. Therefore, in a case where the strip-shaped unit U is rolled, the holding agent 50 is likely to follow the rolling. As a result, the occurrence of a phenomenon in which the rolled strip-shaped unit U is opened again due to the stress of the holding agent 50 is suppressed.

Examples of a specific material of the holding agent 50 include a low-elasticity RTV silicone rubber (for example, “KER-6020-F” manufactured by Shin-Etsu Chemical Co., Ltd.) as a silicone-based adhesive. In addition, even in the case of an epoxy-based adhesive, an adhesive having low elasticity (for example, “FL-288” manufactured by ADEKA Corporation) can be applied. Examples of a specific material of the fixing agent 30 include an epoxy-based adhesive (for example, “353ND” manufactured by Epoxy Technology, Inc.), an acrylic-based adhesive (“AT8224” manufactured by NTT Advanced Technology Corporation), and the like.

However, the above-described materials are examples, and other materials may be used as the holding agent 50 and the fixing agent 30. In addition, even in a case where the materials of the holding agent 50 and the fixing agent 30 are the same, the effect of suppressing the transmission loss of light can be obtained.

As described above, the optical connector 1 of one or more embodiments includes the three or more optical fibers 20, the holding agent 50 that holds the disposition of the optical fibers 20 relative to each other, and the ferrule 10 having the fiber hole 11 into which the three or more optical fibers 20 are inserted together with the holding agent 50. In the cross section (FIG. 3) perpendicular to the longitudinal direction of the fiber hole 11, the core 21c of each optical fiber 20 is disposed on the imaginary circumference C, the optical fibers 20 among the optical fibers 20, which are adjacent to each other in the circumferential direction, are in contact with each other, and the holding agent 50 is disposed further inside the imaginary circumference C in the radial direction than the points where the optical fibers 20 are in contact with each other. According to this configuration, the relative position of the optical fiber 20 is held by the holding agent 50. Therefore, the state where the optical fiber 20 is locally bent inside the fiber hole 11 is suppressed. Therefore, an increase in the transmission loss of light can be suppressed.

In addition, the holding agent 50 is not present at the outermost peripheral portion of each cladding 21d. The “outermost peripheral portion” is a portion of the outer peripheral surface of the cladding 21d, which is closest to the inner surface of the fiber hole 11. In a case where the holding agent 50 is present at the outermost peripheral portion of the cladding 21d, the apparent outer diameter of a bundle of the bare fibers 21 increases by the thickness of the holding agent 50. Then, the holding agent 50 hinders the bare fiber 21 from being inserted into the fiber hole 11. That is, since the holding agent 50 is not present at the outermost peripheral portion of the cladding 21d, the bundle of the bare fibers 21 can be smoothly inserted into the fiber hole 11.

In addition, each of the optical fibers 20 may have the smaller-diameter portion 21a that is positioned inside the fiber hole 11 and the larger-diameter portion 21b that is positioned outside the fiber hole 11 and has a diameter larger than that of the smaller-diameter portion 21a. Such an optical fiber 20 is obtained, for example, by etching the bare fiber 21. Since the smaller-diameter portion 21a has particularly low rigidity, it is difficult to insert the smaller-diameter portion 21a into the fiber hole 11 in this state. In addition, in a case where the smaller-diameter portion 21a is inserted into the fiber hole 11, the smaller-diameter portion 21a is bent or entangled, so that the transmission loss of light is likely to increase. Therefore, as in one or more embodiments, the above-described situations can be addressed by holding the positions of the smaller-diameter portions 21a relative to each other by the holding agent 50.

In addition, the optical connector 1 may further include the fixing agent 30 that fixes the plurality of optical fibers 20 to the fiber hole 11. Accordingly, the optical fiber 20 can be fixed to the fiber hole 11. Moreover, the Young's modulus of the holding agent 50 may be smaller than the Young's modulus of the fixing agent 30. Since the Young's modulus of the holding agent 50 is small, workability in a case where the plurality of optical fibers 20 are inserted into the fiber hole 11 is improved. Since the Young's modulus of the fixing agent 30 is large, the position of each core 21c inside the fiber hole 11 is stabilized.

In addition, in the cross section, the fiber hole 11 may have the linear portion 11b and the curved portion 11a. That is, the fiber hole 11 may have a D shape. In this case, it is easy to control the position of the optical fiber 20 inside the fiber hole 11. More specifically, after the fixing agent 30 is injected into the fiber hole 11, the optical fiber 20 can be pressed against the linear portions 11b to be aligned before the fixing agent 30 is cured. The presence of the linear portion 11b that serves as a positional reference makes it easy to control the position of the optical fiber 20 in the circumferential direction.

In addition, the method for producing the optical connector of one or more embodiments includes the parallel step, the adhesion step, the rolling step, the insertion step, and the fixing step. In the parallel step, the three or more optical fibers 20 are aligned in the first direction X perpendicular to the longitudinal direction Z. In the adhesion step, the holding agent 50 is made to adhere to the optical fiber 20 from one side in the second direction Y perpendicular to both the longitudinal direction Z and the first direction X ((b) of FIG. 4). In the rolling step, the strip-shaped unit U including the optical fibers 20 is rolled such that the holding agent 50 surrounds the optical fibers 20 ((c) of FIG. 4). In the insertion step, the rolled strip-shaped unit U is inserted into the fiber hole 11 of the ferrule 10. In the fixing step, the strip-shaped unit U is fixed to the fiber hole 11 by the fixing agent 30 by injecting the fixing agent 30 into the fiber hole 11.

According to this producing method, the plurality of optical fibers 20 can be inserted into the fiber hole 11 in a state in which the relative positions of the optical fibers 20 are held by the holding agent 50. Therefore, the local bending of the optical fiber 20 when being inserted into the fiber hole 11 is suppressed. Therefore, an increase in the transmission loss of light can be suppressed. Moreover, the entanglement between the optical fibers 20 is also suppressed, and the position of each optical fiber 20 in the circumferential direction is unlikely to change before and after the optical fiber 20 is inserted into the fiber hole 11. Therefore, it is easy to identify each core 21c after completion.

In addition, in the rolling step of the above-described producing method, the strip-shaped unit U may be rolled inside the insertion tool 60. The rolled strip-shaped unit U may be extended from the distal end 60a of the insertion tool 60. Moreover, in the insertion step, the strip-shaped unit U extended from the distal end 60a of the insertion tool 60 may be inserted into the fiber hole 11. According to this producing method, it is easier to insert the strip-shaped unit U into the fiber hole 11 while maintaining the state in which the strip-shaped unit U is rolled.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

For example, in the above-described embodiments, the bare fiber 21 has the smaller-diameter portion 21a and the larger-diameter portion 21b. However, the diameter of the bare fiber 21 may be constant in the longitudinal direction. In this case as well, since the bare fiber 21 is thin, difficulty in inserting the bare fiber 21 into the fiber hole 11 may occur. As described above, according to the above-described embodiments, it is possible to address this.

In addition, in the adhesion step in the above-described producing method, the liquid holding agent 50 is applied to the plurality of optical fibers 20. However, for example, a tape-shaped holding agent 50 may be made to adhere to the plurality of optical fibers 20. In this case, an effect of making it difficult for the holding agent 50 to wrap around the outermost peripheral portion of the bare fiber 21 can be obtained.

In addition, the shape of the insertion tool 60 shown in FIG. 5 is an example, and may be changed. For example, the distal end 60a of the insertion tool 60 may not have the wall portion 63a. Alternatively, the optical fiber 20 may be inserted into the fiber hole 11 without using the insertion tool 60.

In addition, it is possible to appropriately replace the constituent elements in the above-described embodiments with well-known constituent elements without departing from the spirit of the present invention, and the above-described embodiments and modification examples may be appropriately combined.

### REFERENCE SIGNS LIST

1 Optical connector
10 Ferrule
11 Fiber hole
11b Linear portion
20 Optical fiber
21a Smaller-diameter portion
21b Larger-diameter portion
21c Core
30 Fixing agent
50 Holding agent
60 Insertion tool
60a Distal end
C Imaginary circumference
U Strip-shaped unit
X First direction
Y Second direction
Z Longitudinal direction

1. An optical connector comprising:
three or more optical fibers;
a holding agent holding a relative positioning of the three or more optical fibers; and
a ferrule having a fiber hole into which the three or more optical fibers are inserted together with the holding agent, wherein,
in a cross section perpendicular to a longitudinal direction of the fiber hole,
a core of each of the three or more optical fibers is disposed on an imaginary circumference,
adjacent optical fibers of the three or more optical fibers contact each other in a circumferential direction, and
the holding agent is disposed, in a radial direction of the imaginary circumference, inward of a point where the adjacent optical fibers contact each other.

2. The optical connector according to claim 1, wherein each of the three or more optical fibers has:
a smaller-diameter portion disposed inside the fiber hole; and
a larger-diameter portion disposed outside the fiber hole and having a diameter larger than a diameter of the smaller-diameter portion.

3. The optical connector according to claim 1, further comprising:
a fixing agent fixing the three or more optical fibers in the fiber hole and having a material different from a material of the holding agent.

4. The optical connector according to claim 3, wherein the holding agent has a Young's modulus smaller than a Young's modulus of the fixing agent.

5. The optical connector according to claim 1, wherein the fiber hole has a linear portion and a curved portion in the cross section.

6. A method for producing an optical connector, comprising:
aligning three or more optical fibers in a first direction perpendicular to a longitudinal direction of the three or more optical fibers;
adhering a holding agent to the three or more optical fibers from one side in a second direction perpendicular to both the longitudinal direction and the first direction;
rolling a strip-shaped unit including the three or more optical fibers such that the three or more optical fibers surround the holding agent;
inserting the rolled strip-shaped unit into a fiber hole of a ferrule; and
injecting a fixing agent into the fiber hole to fix the rolled strip-shaped unit in the fiber hole with the fixing agent.

7. The method according to claim 6, wherein
in the rolling, the strip-shaped unit is rolled inside an insertion tool,
the method further comprises extending the rolled strip-shaped unit from a distal end of the insertion tool, and
in the inserting, the rolled strip-shaped unit extended from the distal end of the insertion tool is inserted into the fiber hole.
